(19) United States
(12) Patent Application Publication
(10) Pub. No.: US 2015/0285480 A1
(43) Pub. Date: Oct. 8, 2015

(54) LED EXPLOSION-PROOF LAMP

(71) Applicant: Li-Hong Science & Technology Co., Ltd., Kaohsiung (TW)

(72) Inventors: Ming-Tien Chien, Kaohsiung (TW); Ching-Yuan Juan, Kaohsiung (TW); Han-Wen Chang, Kaohsiung (TW); Cheng-Lung Juan, Kaohsiung (TW)

(73) Assignee: Li-Hong Science & Technology Co., Ltd., Kaohsiung (TW)

(21) Appl. No.: 14/247,765

(22) Filed: Apr. 8, 2014

(51) Int. Cl. F21V 25/12; F21V 3/04; F21V 31/00

(52) U.S. Cl. CPC F21V 25/12; F21V 31/005; F21V 3/0418; F21Y 2101/02

(57) ABSTRACT

An LED explosion-proof lamp comprises a holding module, an electric control module, a heat dissipating module, a light emitting module, a covering module and an explosion-proof module. The holding module includes a body and a housing space formed inside the body with an opening. The body includes at least one bracing arm extended from the outer surface thereof horizontally or inclined against the body. The bracing arm has a coupling portion to couple with another LED explosion-proof lamp or for anchoring. The explosion-proof module is disposed in the coupling portion. The invention thus formed can be assembled and installed easily, and coupled in series with other LED explosion-proof lamps at various angles, hence can make the lamp set be configured in greater diversity and versatility.

### FIELD OF THE INVENTION

The present invention relates to a LED explosion-proof lamp and particularly to a LED explosion-proof lamp to facilitate assembly and serial connection.

### BACKGROUND OF THE INVENTION

Industrial locations such as chemical, petrochemical, oilfields, coalmines and the like often are scattered or stocked with gases, dust or chemicals that are inflammable, easily exploded or oxidized, or corrosive. Hence lamps used at those locations must be explosion-proof to avoid incidents of gas explosion or chemical explosion caused by sparks that might be generated by worn out or malfunctioned non explosion-proof lamps.

The wiring of conventional explosion-proof lamps generally has to use an extra explosion-proof cable gland tightly compacting with the cable to enhance air tightness. When connecting one or more explosion-proof lamps in series, an additional explosion-proof wiring box is needed to wire and install the explosion-proof lamps.

Hence installation of the conventional explosion-proof lamps might require extra wiring, or using the explosion-proof cable glade and the wiring box. As a result, the production cost of lamp sets is higher, and installation of the lamps is very inconvenient. All these show that there is still room for improvement.

### SUMMARY OF THE INVENTION

The primary object of the present invention is to provide an LED explosion-proof lamp that can be assembled and installed simpler, and can be easily coupled in series with versatility.

To achieve the foregoing object the LED explosion-proof lamp according to the invention comprises a holding module, an electric control module, a heat dissipating module, a light emitting module, a covering module and an explosion-proof module. The holding module includes a body and a housing space formed inside the body with an opening. The body includes at least one bracing arm extended from an outer surface thereof and a coupling portion with an orifice formed thereon to couple with another LED explosion-proof lamp or for anchoring. The electric control module is held in the housing space and includes a circuit box and a wiring box with a terminal portion. The heat dissipating module connects with the holding module and includes a base and a housing trough. The light emitting module is located on the base and forms electric connection with the electric control module. The covering module includes a cover and a lamp shade that are stacked together. The cover is connected to the heat dissipating module. The lamp shade is held in the housing trough to correspond to the base. The explosion-proof module is disposed in the orifice of the coupling portion.

By means of the above structure, the LED explosion-proof lamp of the invention can provide many advantages, notably:

1. The LED explosion-proof lamp of the invention can be directly wired and used readily, so there is no need to use the conventional explosion-proof cable gland.

2. The LED explosion-proof lamp of the invention can be used individually, and more than one set of the LED explosion-proof lamp can be connected in series without using an extra explosion-proof wiring box.

3. The holding module can be formed in various types to make connection of the LED explosion-proof lamps in greater diversity and versatility.

4. Two or more sets of the LED explosion-proof lamps can be directly fastened together in a head-to-head fashion, and the fastened angle also can be adjusted as desired.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2A is a perspective view of the invention.

FIG. 2B is a cross section view taken on line 2B-2B in FIG. 2A.

FIG. 3 is a schematic view of a single set of the LED explosion-proof lamp of the invention.

FIGS. 4 through 10 are schematic views of embodiments 1 through 7 of the holding module according to the invention.

FIG. 11 is a schematic view of the invention showing two sets of the LED explosion-proof lamps connected in a head-to-head fashion.

FIG. 12 is a schematic view of the invention showing multiple sets of the LED explosion-proof lamps connected in series.

FIG. 13 is a schematic view of another embodiment of the bracing arm of the holding module of the invention.

FIG. 14 is a schematic view of the invention showing multiple sets of the LED explosion-proof lamps coupled together to form a LED explosion-proof lamp set.

### DETAILED DESCRIPTION OF THE PREFERRED EMBODIMENTS

Varying types of embodiments are elaborated below to facilitate discussion of the invention. It is to be noted that same elements are marked by same notations in varying embodiments.

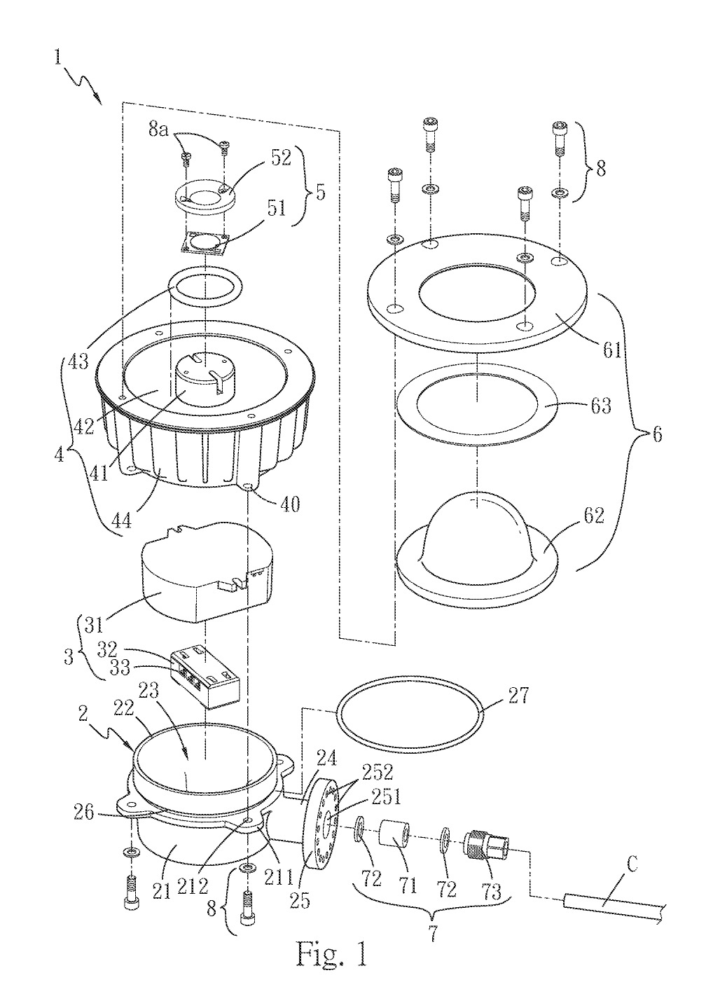

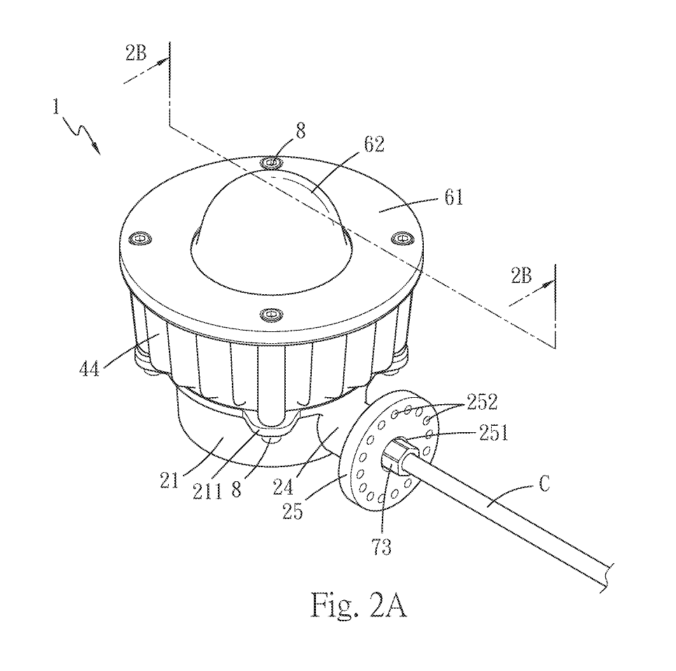

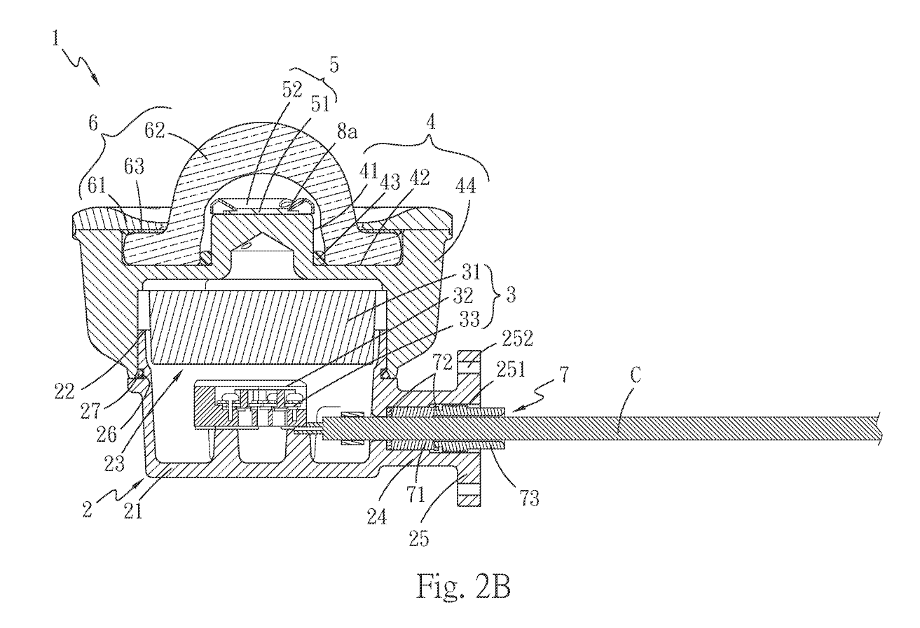

Please referring to FIGS. 1 through 2B, the present invention aims to provide an LED explosion-proof lamp 1. It comprises a holding module 2, an electric control module 3, a cable C, a heat dissipating module 4, a light emitting module 5, a covering module 6 and an explosion-proof module 7.

The holding module 2 includes a body 21 and a housing space 23 formed inside the body with an opening 22. The body 21 includes a bracing arm 24 extended horizontally from an outer surface thereof, and the bracing arm 24 includes a coupling portion 25 to couple with another LED explosion-proof lamp or for mounting directly or indirectly on a wall (not shown in figures) through a connector (not shown in figures) or a bracket (not shown in figures). The coupling portion 25 includes an orifice 251 connecting the housing space 23 and a plurality of fastening holes 252 to couple with another LED explosion-proof lamp at various angles or for anchoring. In this embodiment the fastening holes 252 are formed in a number of sixteen to surround the orifice 251 and spaced from each other at an angle of 22.5 degrees. The holding module 2 also includes a first annular groove 26 on the outer surface thereof to be coupled with a first rubber ring 27, a plurality of extension portions 211 below the first annular groove 26, and a plurality of apertures 212 respectively formed on the plurality of extension portions 211.

The electric control module 3 is held and fastened in the housing space 23, and includes a circuit box 31 and a wiring box 32 with a terminal portion 32. The circuit box 31 contains electronic circuitry to drive the LED explosion-proof lamp 1.

The cable C passes through the orifice 251 of the coupling portion 25 to form electric connection with the electric control module 3.

The heat dissipating module 4 is connected to the holding module 2, and includes a plurality of fastening holes 40 at the bottom thereof corresponding to the apertures 212 of the holding module 2 that are run through by a plurality of fasteners 8 to fasten the heat dissipating module 4 to the holding module 2. The heat dissipating module 4 further includes a base 41, a housing trough 42 and a plurality of heat dissipating fins 44 formed on an outer surface thereof. The base 41 is coupled with a second rubber ring 43.

The light emitting module 5 is fastened to the base 41, and includes a substrate 51 to hold at last one LED light emitting element and an ornamental plate 52. The substrate 51 is electrically connected to the electric control module 3. The plurality of fasteners 8 run through the ornamental cover 52 and the substrate 51 and fasten to the corresponding fastening holes formed on the base 41 of the heat dissipating module 4, so as to fasten the light emitting module 5 to the base 41.

The covering module 6 includes a cover 61 and a lamp shade 62 that are stacked together, and a second gasket 63 interposed between the cover 61 and the lamp shade 62. The lamp shade 62 is made of tempered glass and held in the housing trough 42 to correspond to the base 41. The cover 61 is fastened to the heat dissipating module 4 through using the plurality of fasteners 8 to run through the cover 61 and fasten to the corresponding fastening apertures formed on the heat dissipating module 4.

The explosion-proof module 7 is disposed in the orifice 251 of the coupling portion 25, and includes an explosion-proof member 71 threaded through by the cable C, two first gaskets 72 which are respectively disposed at two ends of the explosion-proof member 71 and also run through by the cable C, and a compact bolt 73 disposed at one end of the explosion-proof member 71 remote from the coupling portion 25 and run through by the cable C. The explosion-proof member 71 is made of explosion-proof rubber. The compact bolt 73 is made of metal.

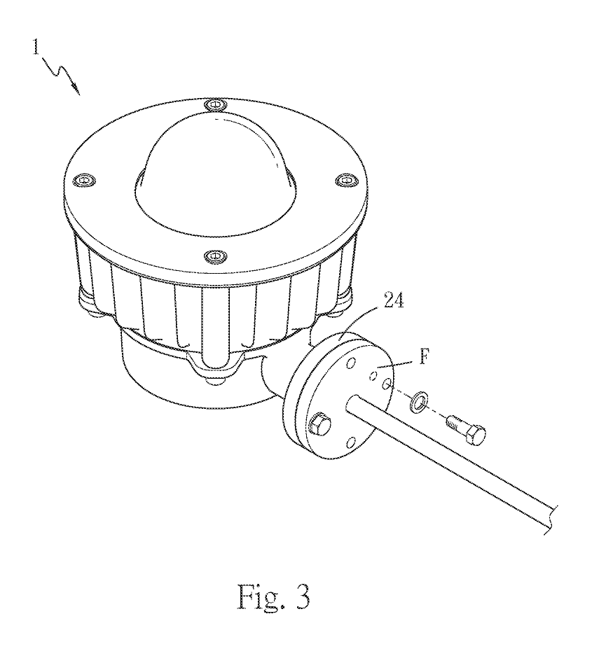

Please referring to FIG. 3, when the LED explosion-proof lamp 1 of the invention is applied individually, it further includes a disk F to connect with the coupling portion 25. The disk F can be a flange or other adapters.

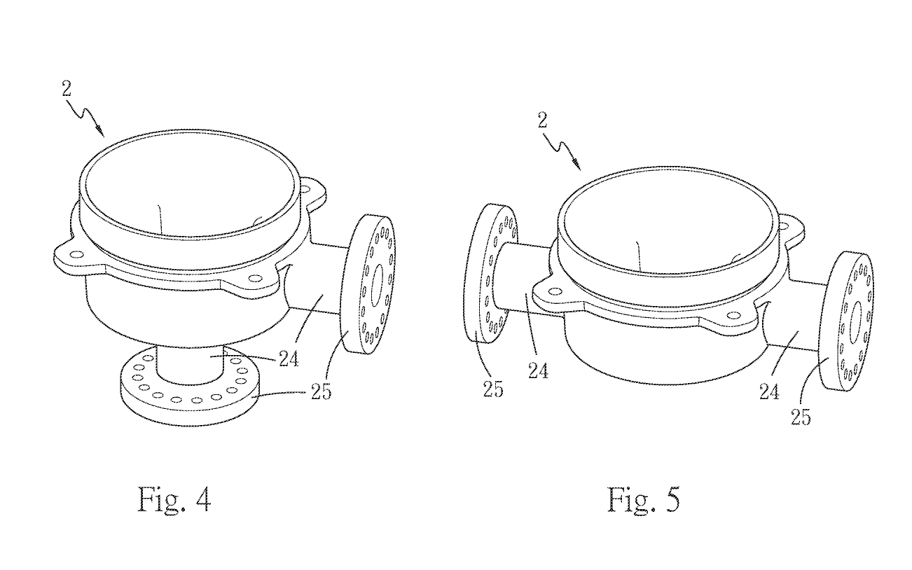

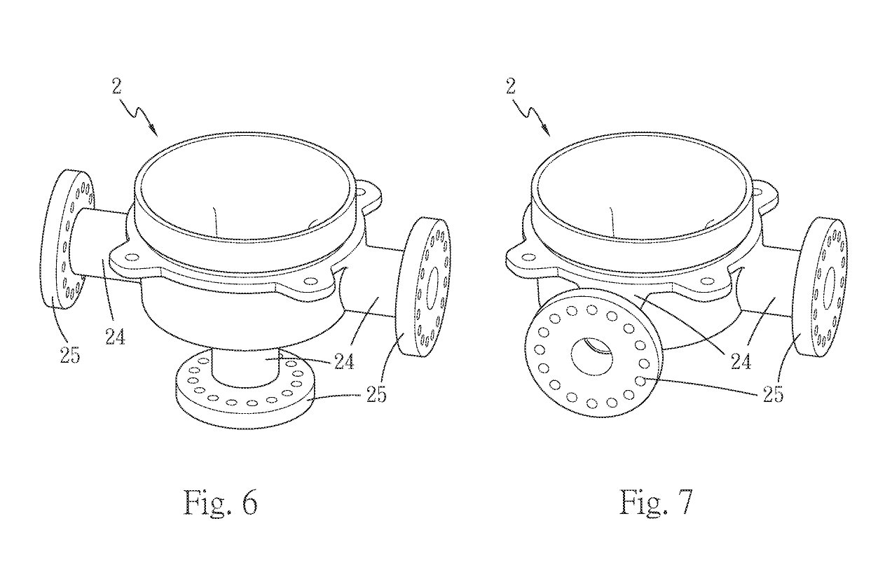

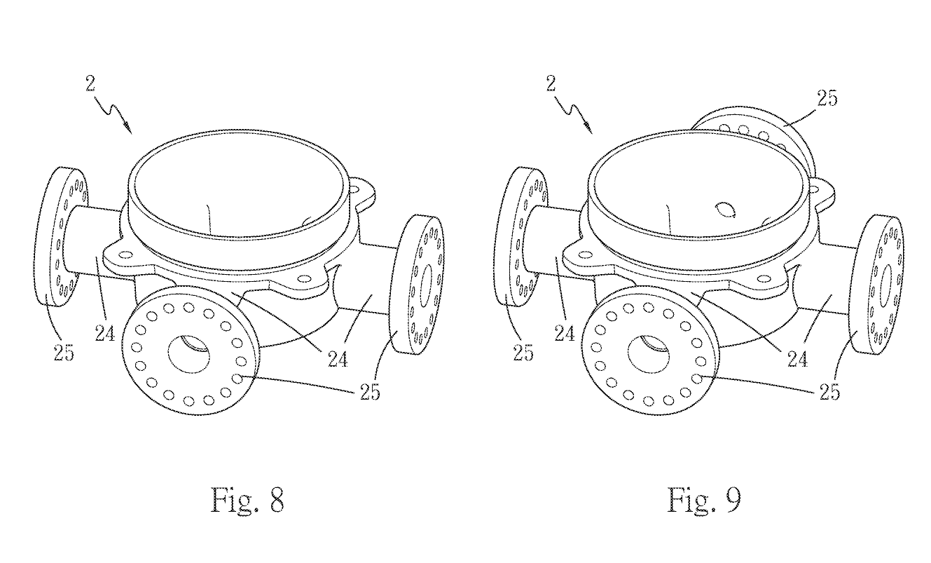

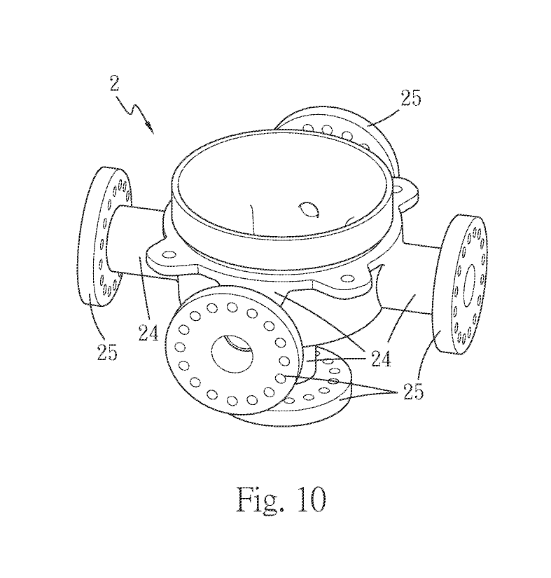

The at least one bracing arm 24 of the holding module 2 of the invention can be formed on the outer surface of the body 21 in various types, as shown in FIG. 4 through FIG. 10. According to applicable function desired, they can be a suspension type, a horizontal head-to-head connection type, a suspension and horizontal head-to-head connection type, an L-shape connection type, an T-shape connection type, a cross connection type and a suspension and cross connection type.

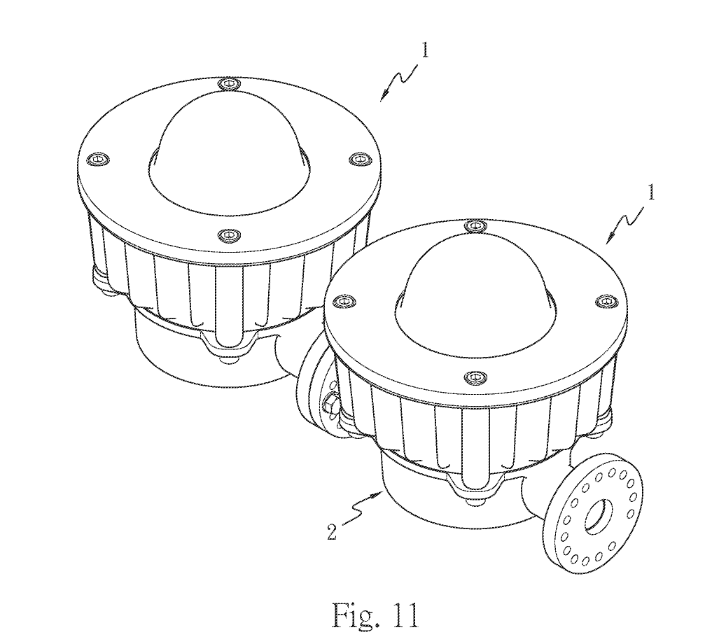

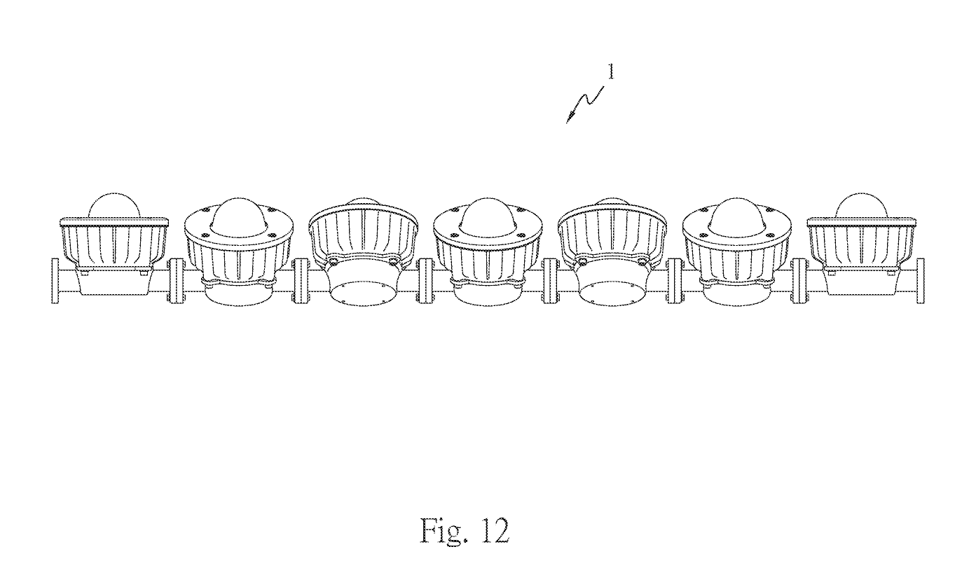

Please also referring to FIG. 11, one LED explosion-proof lamp 1 can be directly coupled with another LED explosion-proof lamp 1 in a head-to-head fashion (i.e., adopting the holding module 2 shown in FIG. 5), and is ready for use upon threading the cable C through the coupling portion 25 to receive electric power. Referring to FIG. 12, several LED explosion-proof lamps 1 can also be connected with each other at varying angles respectively.

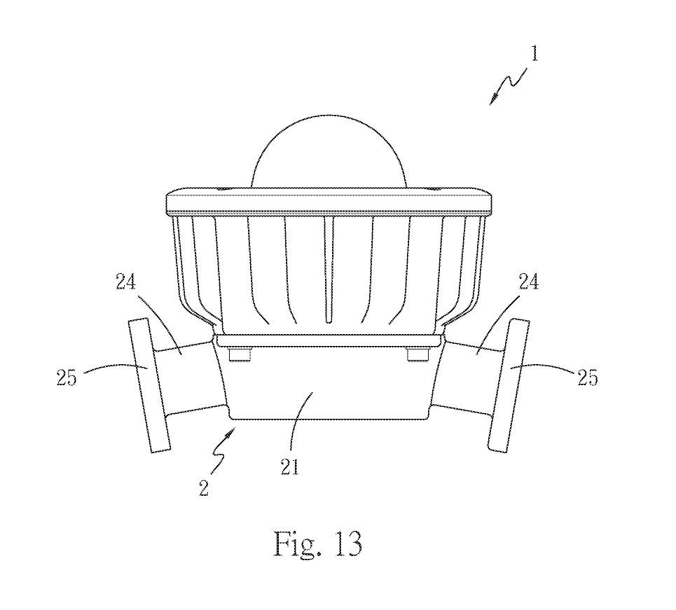

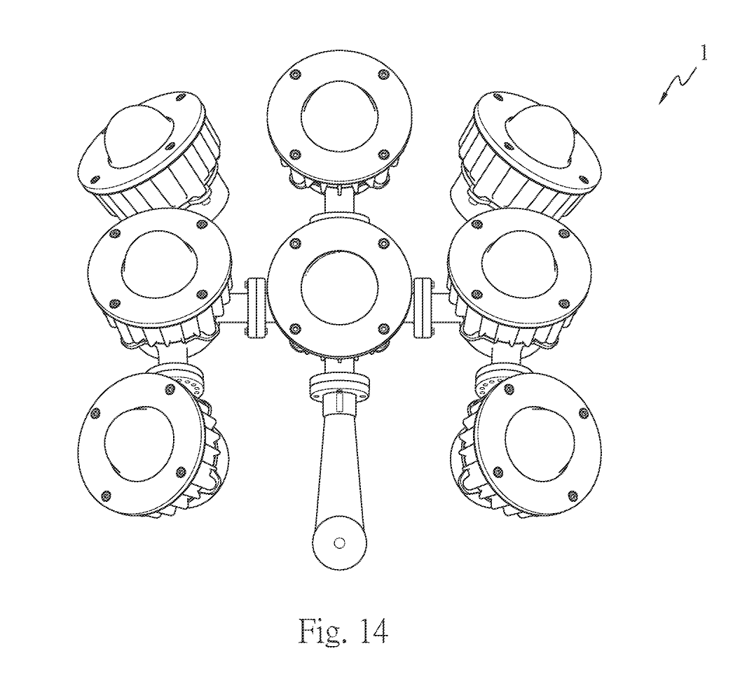

In addition, please referring to FIG. 13 for yet another embodiment, in which the bracing arm 24 and the coupling portion 25 are formed in an inclined manner against the body 21 of the holding module 2. Moreover, the holding module 2 of the LED explosion-proof lamp 1 in this embodiment can adopt various types as shown in FIG. 4 through FIG. 10. FIG. 14 also illustrates yet another embodiment in which the LED explosion-proof lamps 1 with the horizontal bracing arms are coupled with the LED explosion-proof lamps 1 with the inclined bracing arms, thereby provides greater diversity and versatility of lamp styles.

As a conclusion, the LED explosion-proof lamp of the invention provides explosion-proof function through the explosion-proof member, the two first gasket and the compact bolt without using the conventional explosion-proof cable gland, and can be directly used by a single set of the explosion-proof lamp, or couple multiple sets of the explosion-proof lamps in various connecting fashion, such as being fastened at different angles or using different types of the holding modules to form various series connection, thus can achieve greater diversity and versatility when in use.

What is claimed is:

1. An LED explosion-proof lamp, comprising:
a holding module including a body and a housing space formed inside the body with an opening, the body including at least one bracing arm extended from an outer surface thereof, the at least one bracing arm including a coupling portion with an orifice formed thereon to couple with another LED explosion-proof lamp or for anchoring, ;
an electric control module which is held in the housing space and includes a circuit box and a wiring box with a terminal portion;
a heat dissipating module which is connected to the holding module and includes a base and a housing trough;
a light emitting module which is fastened to the base of the heat dissipating module and electrically connected to the electric control module;
a covering module which includes a cover and a lamp shade that are stacked together, the cover being connected to the heat dissipating module, the lamp shade being held in the housing trough to correspond to the base; and
an explosion-proof module disposed in the orifice of the coupling portion.

2. The LED explosion-proof lamp of claim 1, wherein the explosion-proof module includes an explosion-proof member, two first gaskets respectively disposed at two ends of the explosion-proof member and a compact bolt disposed at one end of the explosion-proof member remote from the coupling portion.

3. The LED explosion-proof lamp of claim 2, wherein the explosion-proof member is made of explosion-proof rubber, and the compact bolt is made of metal.

4. The LED explosion-proof lamp of claim 1, wherein the coupling portion includes a plurality of fastening holes to couple with the another LED explosion-proof lamp at varying angles or for anchoring.

5. The LED explosion-proof lamp of claim 4 further including a disk which is a flange to connect with the coupling portion.

6. The LED explosion-proof lamp of claim 1, wherein the holding module includes a first annular groove to be coupled with a first rubber ring.

7. The LED explosion-proof lamp of claim 1, wherein the base is coupled with a second rubber ring.

8. The LED explosion-proof lamp of claim 1, wherein the bracing arm is horizontal or inclined against the body.

9. The LED explosion-proof lamp of claim 1, wherein the covering module includes a second gasket interposed between the cover and the lamp shade, the lamp shade being made from tempered glass.

10. The LED explosion-proof lamp of claim 1, wherein the light emitting module includes a substrate to hold at least one light emitting element and an ornamental plate, the substrate and the ornamental plate being fastened to the base.
